(19) United States
(12) Patent Application Publication
(10) Pub. No.: US 2014/0182464 A1
(43) Pub. Date: Jul. 3, 2014

(54) SCRAPER DEVICE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: Fu-Tao ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/138,132

(22) Filed: Dec. 23, 2013

(30) Foreign Application Priority Data
Dec. 28, 2012 (CN) 2012105820987

(51) Int. Cl. B41F 15/44

(52) U.S. Cl. CPC B41F 15/44
USPC 101/123

(57) ABSTRACT

A scraper device is applied to a solder paste printer for scraping solder paste on a surface of a stencil. The scraper device comprises a supporting structure, a scraper fixed to the supporting structure, two blocking members positioned at opposite ends of the scraper respectively and coupled to the supporting structure, and two adjusting structures moveably mount the two blocking members to the supporting structure correspondingly. When the scraper scrapes the solder paste, the scraper and the two blocking members are slid on the surface of the stencil, the adjusting structure adjusts a friction between each blocking member and the surface to a predetermined level.

### BACKGROUND

1. Technical Field

The present disclosure relates to a scraper device for a solder paste printer.

2. Description of Related Art

A solder paste printer typically includes a transferring device, a scraper device mounted on the transferring device, a stencil including a surface for placing solder paste and defining a number of through holes, and a supporting member for supporting a printed circuit board (PCB). The surface of the stencil is facing the scraper device. The PCB is covered by the stencil and opposite to the surface of the stencil. The transferring device drives the scraper device to slide on the surface of the stencil to deposit the solder paste on the PCB via the through holes.

The scraper device includes a holder member, a scraper, and two blocking members. The holder member is mounted on the transferring device. The scraper is mounted on the holder member and is inclined to the surface of the stencil. The transferring device drives the scraper to slide on the surface to deposit the solder paste on the PCB. The two blocking members are fixed to the holder member and are positioned on opposite end portions of the scraper, so as to prevent the solder paste from flowing out of the scraper from the opposite end portions of the scraper. When the scraper device scrapes the solder paste, the scraper device is pressed on the surface of the stencil. However, because the stencil is very thin, two edges of the stencil beside the two blocking members could be warped under the pressure. Thus, a friction between the blocking member and the stencil will increase, and the blocking member will be damaged quickly.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a sectional view of a solder paste printer in accordance with an embodiment.

FIG. 2 is a partial isometric view of a solder paste printer in FIG. 1.

FIG. 3 is an exploded view of the first scraper device in FIG. 2.

FIG. 4 is a partial exploded view of the first scraper device in FIG. 2 from another aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

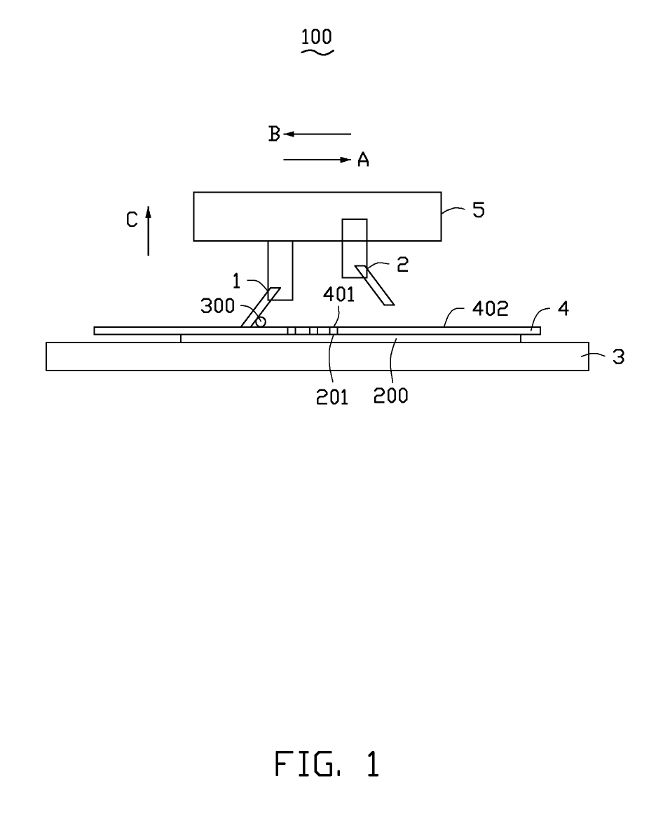

FIG. 1 shows a solder paste printer 100 in accordance with an embodiment. The solder paste printer 100 deposits solder paste 300 on a printed circuit board (PCB) 200. The PCB 200 has a number of pre-welding positions 201 where the solder paste 300 are deposited. The solder paste printer 100 includes a first scraper device 1, a second scraper device 2, a supporting member 3, a stencil 4, and a transferring device 5. The first scraper device 1 and the second scraper device 2 are mounted on the transferring device 5. The stencil 4 defines a number of holes 401 corresponding to the pre-welding positions 201. The stencil 4 includes a surface 402 facing the first scraper device 1 and the second scraper device 2. When the solder paste printer 100 deposits the solder paste 300 on the PCB 200, the PCB 200 is placed on the supporting member 3 and is covered by the stencil 4. The transferring device 5 drives the first scraper device 1 and the second scraper device 2 to move in a first direction A parallel with the surface 402 and a second direction B opposite to the first direction A. The transferring device 5 also drives the first scraper device 1 and the second scraper device 2 to move up and down in a third direction C perpendicular to the surface 402. When the first scraper device 1 and the second scraper device 2 are moved in the first direction A, the first scraper device 1 contacts with the surface 402 for depositing the solder paste 300 on the PCB 200 via the holes 401. The second scraper device 2 is away from the surface 402. When the first scraper device 1 and the second scraper device 2 are moved in the second direction B, the second scraper device 2 contacts with the surface 402 for depositing the solder paste 300 on the PCB 200 through the holes 401. The first scraper device 1 is away from the surface 402.

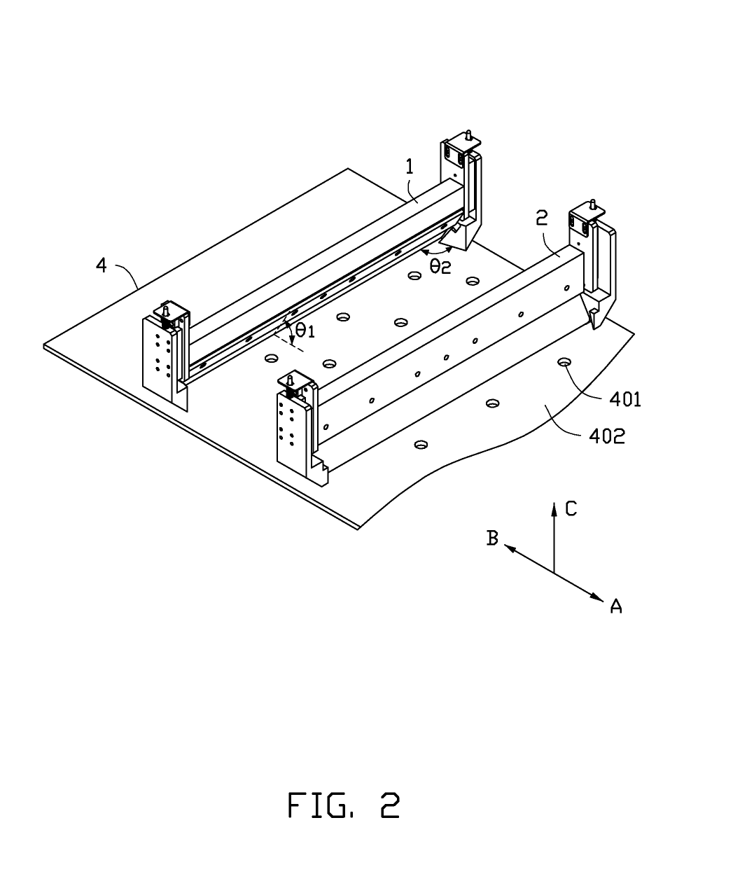

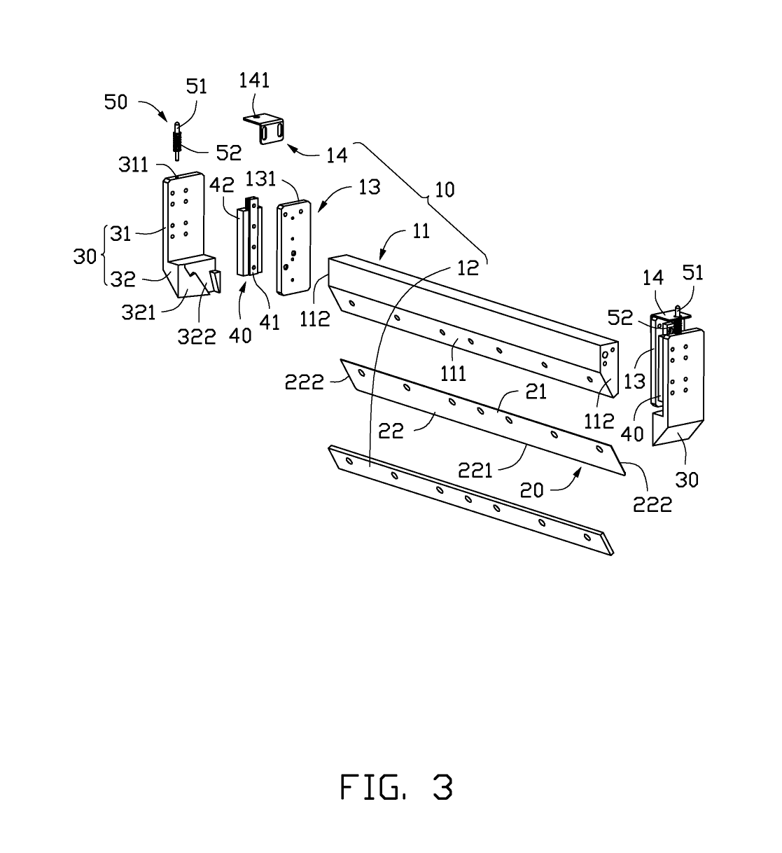

FIGS. 2 and 3 show that the first scraper device 1 and the second scraper device 2 are symmetrically fixed to the transferring device 5. The first scraper device 1 and the second scraper device 2 are substantially the same. Both of the first scraper device 1 and the second scraper device 2 includes a supporting structure 10, a scraper 20 fixed to the supporting structure 10, two blocking members 30 positioned at opposite ends of the scraper 20 respectively. In addition, both of the first scraper device 1 and the second scraper device 2 includes two guiding structures 40 for guiding the two blocking members 30 respectively, and two adjusting structures 50 for adjusting the two blocking members 30 respectively.

The supporting structure 10 is mounted on the transferring device 5. The supporting structure 10 includes a main body 11, a retainer plate 12, two connecting members 13, and two stopping members 14. The main body 11 includes a first mounting portion 111 and two second mounting portions 112. The first mounting portion 111 is positioned at the bottom of the main body 11. The two second mounting portions 112 are positioned at opposite ends of the main body 11 respectively. The retainer plate 12 is fixed to the first mounting portion 111 for clamping the scraper 20. The two connecting members 13 are mounted on the two second mounting portions 112 correspondingly. An end 131 of the connecting member 13 protrudes out of the main body 11 in the third direction C. The two stopping members 14 are mounted on the two ends 131 correspondingly. The stopping member 14 includes a stopping hole 141.

The scraper 20 is mounted on the supporting structure 10. The scraper 20 includes a positioning portion 21 and a scraping portion 22. The positioning portion 21 is clamped and is fastened between the first mounting portion 111 and the retainer plate 12. The scraping portion 22 includes a bottom edge 221 and two lateral edges 222 perpendicular to the bottom edge 221. When the scraper 20 is mounted on the supporting structure 10, the scraper 20 is inclined at a first angle θ₁ relative to the surface 402. The bottom edge 221 is parallel with the surface 402. In one embodiment, the first angle θ₁ is 58°.

Each blocking member 30 includes a fixing portion 31 and a blocking portion 32. An end of the fixing portion 31 defines a fixing hole 311 corresponding to the stopping hole 141. The blocking portion 32 is bent to the scraper 20 from another end of the fixing portion 31, which is opposite to the fixing hole 311. The blocking portion 32 includes an inclined plane 321 relative to the scraper 20, and defines a groove 322 on a side facing the scraper 20. The inclined plane 321 and the scraper 20 form a second angle θ₂. The range of the second angle θ₂ depends on the amount of the solder paste 300. The second angle θ₂ is in a range from 120° to 160°. The groove 322 receives the lateral edge 222 of the scraper 20. The width of the groove 322 is larger than the thickness of the scraper 20. Thus, when the scraper 20 scrapes the solder paste 300, the groove 322 will allow a little deformation of the scraper 20. In one embodiment, the blocking member 30 is made of polyoxymethylene (POM) material, such that the friction between the blocking member 30 and the surface 402 of the stencil 4 is small.

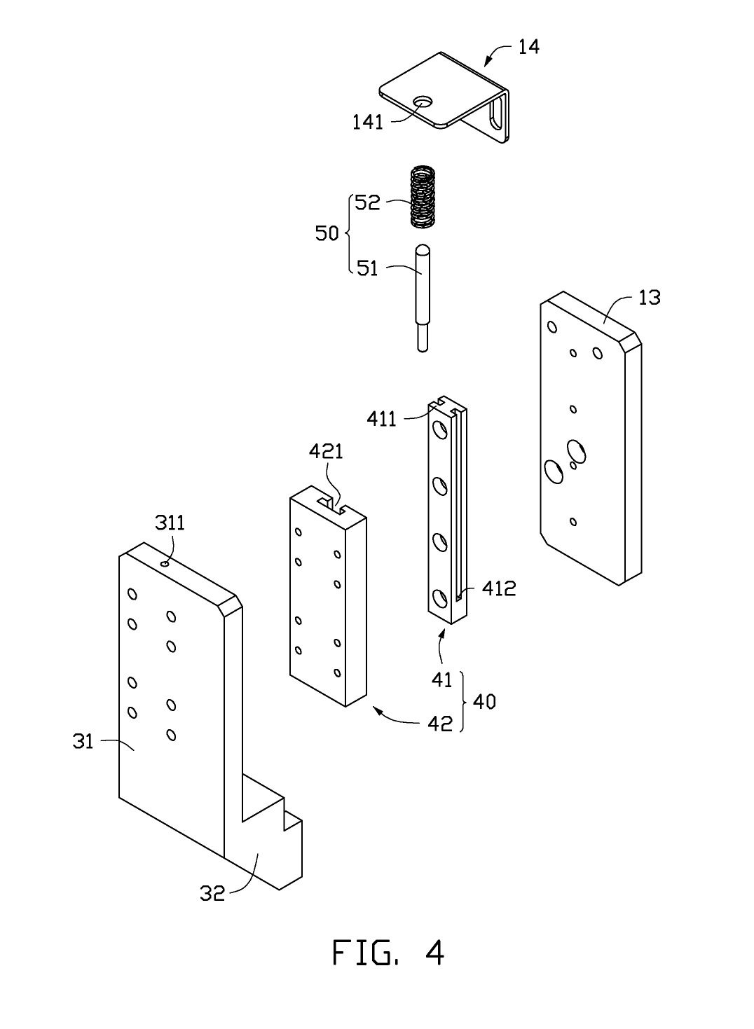

FIG. 4 shows that each guiding structure 40 includes a first guiding member 41, and a second guiding member 42 slidably coupled to the first guiding member 41. The first guiding member 41 is mounted on the connection member 13. The first guiding member 41 includes a rail 411 having a T-shaped cross-section perpendicular to the third direction C, and a stopping portion 412 adjacent to the surface 402. The second guiding member 42 is mounted on the fixing portion 31. The second guiding member 42 defines a sliding groove 421 for receiving the rail 411. The sliding groove 421 has a T-shaped cross-section perpendicular to the third direction C. When the sliding groove 421 receives the rail 411, the second guiding member 42 can slide relative to the first sliding member 41 in the third direction C. The stopping portion 412 stops the second guiding member 42 at a predetermined position where the bottom of the blocking member 30 is slightly lower than the bottom edge 221 of the scraper 20.

Each adjusting structure 50 includes a rod member 51 and an elastic member 52 sleeved on the rod member 51. An end of the rod member 51 is movably connected to the stopping member 14 through the stopping hole 141. The other end of the rod member 51 is inserted into the fixing hole 311 and is fixed to the fixing portion 31. The rod member 51 is configured to control a direction of deformation of the elastic member 52. The elastic member 52 is positioned between the stopping member 14 and the blocking member 30. The elastic member 52 is compressed to apply a proper force to the blocking member 30. In some embodiments, the elastic member 52 is a spring. An end of the elastic member 52 abuts the stopping member 14, and the other end abuts the blocking portion 31.

When the first scraper device 1 is assembled, the scraper 20 is fixed to the first mounting portion 111. The blocking member 30 is movably coupled to the connecting member 13 in the third direction C through the guiding structure 40. The adjusting structure 50 is positioned between the stopping member 14 and the blocking member 30. The elastic member 52 is compressed to supply a force to the blocking member 30. The stopping portion 412 blocks the second guiding member 42. The bottom of the blocking member 30 is slightly lower than the bottom edge 221 of the scraper 20. The second scraper device 2 can be assembled in the same manner.

In operation, when a position on the stencil is warped, and the blocking member 30 encounters the warped position, the blocking member 30 will move in the third direction C and compress the elastic member 52. Thus, the friction between the blocking member 30 and the surface 402 is maintained in a predetermined level to extend the service life of the blocking member 30.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A scraper device applied to a solder paste printer for scraping solder paste on a surface of a stencil, the scraper device comprising:
a supporting structure;
a scraper fixed to the supporting structure;
two blocking members positioned at opposite ends of the scraper respectively and coupled to the supporting structure; and
two adjusting structures moveably mounting the two blocking members to the supporting structure correspondingly;
wherein when the scraper scrapes the solder paste, the scraper and the two blocking members are slid on the surface of the stencil, the adjusting structure adjusts a friction between each blocking member and the surface to a predetermined level.

2. The scraper device of claim 1, wherein each adjusting structure comprises an elastic member positioned between the supporting structure and the blocking member, the elastic member is compressed to apply a force to the blocking member in a direction perpendicular to the surface to force the blocking member to move towards the surface along the direction perpendicular to the surface.

3. The scraper device of claim 2, wherein the adjusting structure further comprises a rod member moveably connected to the supporting structure and fixed to the blocking member, the rod member is configured to control a direction of deformation of the elastic member.

4. The scraper device of claim 3, wherein the supporting structure comprises a main body and a stopping member protruded out of the main body in the direction perpendicular to the surface, the stopping member defines a stopping hole, the rod member is movably connected to the stopping member through the stopping hole.

5. The scraper device of claim 3, wherein the elastic member is sheathed on the rod member, one end of the elastic member abuts the supporting structure, and the other end of the elastic member abuts the blocking member.

6. The scraper device of claim 2, wherein the scraper device further comprises two guiding structures, each guiding structure comprises a first guiding member and a second guiding member slidably connected to the first guiding member, the first guiding member and the second guiding member are fixed to the supporting structure and the blocking member respectively so that the blocking member is moveably connected to the supporting structure in the direction perpendicular to the surface.

7. The scraper device of claim 6, wherein the first guiding member comprises a rail along the direction perpendicular to the surface, the second guiding member comprises a sliding groove for receiving the rail, when the sliding groove receives the rail, the second guiding member can slide relative to the first sliding member in the direction perpendicular to the surface.

8. The scraper device of claim 7, wherein the first guiding member further comprises a stopping portion adjacent to the surface, when the elastic member is compressed to apply a force to the blocking member in a direction perpendicular to the surface, the stopping portion stops the second guiding member at a predetermined position where the bottom of the blocking member is slightly lower than the bottom of the scraper.

9. The scraper device of claim 1, wherein each blocking member comprises a fixing portion and a blocking portion bent to the scraper from one end of the fixing portion adjacent to the surface, the blocking portion defines a groove for receiving one end of the scraper.

10. A scraper device applied to a solder paste printer for scraping solder paste on a surface of a stencil, the scraper device comprising:
a supporting structure;
a scraper fixed to the supporting structure and able to slide on the surface of the stencil for scraping the solder paste;
two blocking members positioned at opposite ends of the scraper respectively and able to slide on the surface of the stencil to prevent the solder paste from flowing out of the opposite ends of the scraper; and
two adjusting structures fixed to the two blocking members correspondingly and moveably mounted on the supporting structure, the adjusting structure capable of making the two blocking members move relative to the supporting member in a direction perpendicular to the surface of the stencil when a portion of the stencil corresponding to the blocking member is warped.

11. The scraper device of claim 10, wherein each adjusting structure comprises an elastic member positioned between the supporting structure and the blocking member, the elastic member is compressed to apply a force to the blocking member in a direction perpendicular to the surface to force the blocking member to move towards the surface along the direction perpendicular to the surface.

12. The scraper device of claim 11, wherein the adjusting structure further comprises a rod member moveably connected to the supporting structure and fixed to the blocking member, the rod member is configured to control a direction of deformation of the elastic member.

13. The scraper device of claim 12, wherein the supporting structure comprises a main body and a stopping member protruding out of the main body in the direction perpendicular to the surface, the stopping member defines a stopping hole, the rod member is movably connected to the stopping member through the stopping hole.

14. The scraper device of claim 12, wherein the elastic member is sheathed on the rod member, one end of the elastic member abuts the supporting structure, and the other end of the elastic member abuts the blocking member.

15. The scraper device of claim 11, wherein the scraper device further comprises two guiding structures, the guiding structure comprises a first guiding member and a second guiding member slidably connected to the first guiding member, the first guiding member and the second guiding member are fixed to the supporting structure and the blocking member respectively so that the blocking member is moveably connected to the supporting structure in the direction perpendicular to the surface.

16. The scraper device of claim 15, wherein the first guiding member comprises a rail along the direction perpendicular to the surface, the second guiding member comprises a sliding groove for receiving the rail, when the sliding groove receives the rail, the second guiding member can slide relative to the first sliding member in the direction perpendicular to the surface.

17. The scraper device of claim 16, wherein the first guiding member further comprises a stopping portion adjacent to the surface, when the elastic member is compressed to apply a force to the blocking member in a direction perpendicular to the surface, the stopping portion stops the second guiding member at a predetermined position where the bottom of the blocking member is slightly lower than the bottom of the scraper.

18. The scraper device of claim 10, wherein each blocking member comprises a fixing portion and a blocking portion bent to the scraper from one end of the fixing portion adjacent to the surface, the blocking portion defines a groove for receiving one end of the scraper.
